(19) United States
(12) Patent Application Publication
(10) Pub. No.: US 2010/0157210 A1
(43) Pub. Date: Jun. 24, 2010

(54) REFLECTIVE-TYPE LIQUID CRYSTAL DISPLAY PANEL, METHOD OF MANUFACTURING DISPLAY SUBSTRATE USED IN THE DISPLAY PANEL, AND METHOD OF MANUFACTURING THE DISPLAY PANEL

(76) Inventors: Soon-Joon RHO, Gyeonggi-do (KR); Baek-Kyun JEON, Gyeonggi-do (KR); Hee-Keun LEE, Gyeonggi-do (KR)

Correspondence Address: Haynes and Boone, LLP;IP Section, 2323 Victory Avenue, SUITE 700, Dallas, TX, 75219, US

(21) Appl. No.: 12/505,375

(22) Filed: Jul. 17, 2009

(30) Foreign Application Priority Data
Dec. 18, 2008 (KR) 2008-129009

(51) Int. Cl. G02F 1/1335; G02F 1/13

(52) U.S. Cl. 349/104; 349/187

(57) ABSTRACT

A reflective-type liquid crystal display (LCD) panel includes a light-absorbing layer, in accordance with an embodiment of the present invention. A roughness of a surface of the light-absorbing layer may be treated by atmospheric plasma or an ion beam. The LCD panel may include a protective layer formed on the light-absorbing layer. The LCD panel may include a cholesteric liquid crystal. According to embodiments of the present invention, the brilliance degree and reflectivity of the light-absorption layer may be reduced. As such, the contrast ratio of the reflective-type LCD panel may be increased.

### RELATED APPLICATIONS

This application claims priority to and the benefit of Korean Patent Application No. 2008-129009, filed on Dec. 18, 2008, in the Korean Intellectual Property Office (KIPO), the contents of which are herein incorporated by reference in their entirety.

### BACKGROUND

1. Technical Field

Example embodiments of the present invention relate to a reflective-type liquid crystal display (LCD) panel and a method of manufacturing a display substrate used in the display panel, and a method of manufacturing the display panel. More particularly, example embodiments of the present invention relate to a reflective-type LCD panel for increasing a contrast ratio, a method of manufacturing a display substrate used in the display panel, and a method of manufacturing the display panel.

2. Related Art

A conventional liquid crystal display (LCD) panel comprises a lower substrate having a pixel electrode, an upper substrate having a common electrode, and a liquid crystal layer interposed between the lower substrate and the upper substrate. When an electric field is applied to the pixel electrode and the common electrode, the arrangement of liquid crystal molecules of the liquid crystal layer is changed, and the optical transmittance of the liquid crystal molecules is controlled by the changed arrangement of the liquid crystal molecules to display an image.

An LCD panel is considered a passive-type display device because it does not emit light by itself. A conventional transmissive-type LCD panel includes a backlight assembly for providing the LCD panel with light. However, the backlight assembly consumes a large amount of power and increases the thickness and weight of the LCD device. Generally, it is desirable that mobile devices, such as an electronic book, electronic paper, etc., have a thinner thickness, are light weight, and have a lower power consumption. As such, a high power consumption and a heavier weight of the backlight assembly may reduce the competitiveness of the LCD device.

Contrary to the transmissive-type LCD device, a reflective-type LCD device controls optical transmittance of the liquid crystal molecules by reflecting natural light or externally provided artificial light. Thus, the reflective-type LCD device has an advantage of lighter weight and lower power consumption, as compared to the transmissive-type LCD device. However, the reflective-type LCD device has a relatively low luminance and a low contrast ratio that is the ratio of the luminance of the brightest color to that of the darkest color. Therefore, there currently exists a need to increase the contrast ratio of reflective-type LCD devices.

### SUMMARY

Example embodiments of the present invention provide a reflective-type liquid crystal display (LCD) panel having an improved contrast ratio. Example embodiments of the present invention provide a method of manufacturing a display substrate used in the display panel. Example embodiments of the present invention provide a method of manufacturing the LCD panel.

In accordance with an embodiment of the present invention, a reflective-type LCD panel includes a first substrate, a second substrate, and a liquid crystal layer. The first substrate includes a first base substrate, a light-absorbing layer, and a pixel electrode. The light-absorbing layer has a first surface facing the first base substrate and a second surface opposite to the first surface. The second surface has greater roughness than that of the first surface. The pixel electrode is formed on the light-absorbing layer. The second substrate includes a common electrode facing the pixel electrode. The liquid crystal layer is disposed between the first substrate and the second substrate.

In one example embodiment of the present invention, the second surface of the light-absorbing layer may be treated by using atmospheric plasma or an ion beam.

In some example embodiments of the present invention, the second surface of the light-absorbing layer may include a plurality of protrusions having random shapes. The protrusions may be formed on a whole of the second surface. The light-absorbing layer may be an organic layer including carbon black.

In some example embodiments of the present invention, the LCD panel may include a protective layer formed on the light-absorbing layer to cover the light-absorbing layer. The protective layer may comprise silicon oxide.

In one example embodiment of the present invention, the liquid crystal layer may comprise a cholesteric liquid crystal. A texture state of the cholesteric liquid crystal may be a homeotropic state during display of a black image.

In one example embodiment of the present invention, the LCD panel may include a plurality of walls formed between the pixel electrodes.

In accordance with an embodiment of the present invention, there is provided a method of manufacturing a display substrate in an LCD device. In this method, a light-absorbing layer is formed on a base substrate. A surface of the light-absorbing layer is treated to increase the roughness of the surface of the light-absorbing layer. A switching element is formed on the light-absorbing layer. A transparent electrode is electrically connected to the switching element.

In one example embodiment of the present invention, forming the light-absorbing layer may include depositing a light-absorbent organic layer on the base substrate and treating the light-absorbent organic layer by heat to cure the light-absorbent organic layer. The light-absorbent organic layer may include carbon black.

In one example embodiment of the present invention, treating the surface of the light-absorbing layer may include increasing the roughness of the light-absorbing layer by using atmospheric plasma. Alternatively, treating the surface of the light-absorbing layer may include increasing the roughness of the light-absorbing layer by irradiating an ion beam to the light-absorbing layer.

In one example embodiment of the present invention, the method may include forming a protective layer on the light-absorbing layer after treating the surface of the light-absorbing layer. The protective layer may comprise silicon oxide formed at a temperature lower than about 150° C.

In accordance with an embodiment of the present invention, there is provided a method of manufacturing the LCD device. In this method, a light-absorbing layer is formed on a first substrate. A surface of the light-absorbing layer is treated to increase the roughness of the surface of the light-absorbing layer. A pixel electrode is formed in each pixel area of the first substrate. A second substrate including a common electrode facing the pixel electrode is formed. A cholesteric liquid crystal layer is disposed between the first substrate and the second substrate.

In one example embodiment of the present invention, the light-absorbing layer may be an organic layer including carbon black. Treating the surface of the light-absorbing layer may include increasing the roughness of the light-absorbing layer by using atmospheric plasma. The method may include forming a protective layer on the light-absorbing layer after treating the surface of the light-absorbing layer.

According to some example embodiments of the present invention, the brilliance degree and reflectivity of a light-absorption layer of a reflective-type LCD panel may be reduced. Accordingly, the contrast ratio of the reflective-type LCD panel may be increased.

Moreover, atmospheric plasma may be used to treat a surface of the light-absorption layer in an example embodiment of the present invention. Thus, a process of the surface treatment may be simplified. Accordingly, costs of manufacturing the reflective-type LCD panel may be reduced.

### BRIEF DESCRIPTION OF THE DRAWINGS

The above and other features and advantages of the present invention will become more apparent by describing in detailed example embodiments thereof with reference to the accompanying drawings.

FIG. 1 is a cross-sectional view illustrating a liquid crystal display (LCD) panel, in accordance with an example embodiment of the present invention;

FIG. 2 is a flowchart describing a method of manufacturing the LCD panel illustrated in FIG. 1, in accordance with an example embodiment of the present invention;

FIGS. 3A to 3H are cross-sectional views for describing processes of the method of manufacturing the LCD panel illustrated in FIG. 1, in accordance with one or more example embodiments of the present invention;

FIG. 4 is a graph showing the brilliance degree of the light-absorption layer after the surface of the light-absorption layer is treated by atmospheric plasma, in accordance with an example embodiment of the present invention; and

FIG. 5 is a graph showing the reflectivity of the light-absorption layer before and after the surface of the light-absorption layer is treated by the atmospheric plasma, in accordance with an example embodiment of the present invention.

### DETAILED DESCRIPTION

Embodiments of the present invention are described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be explained in detail with reference to the accompanying drawings.

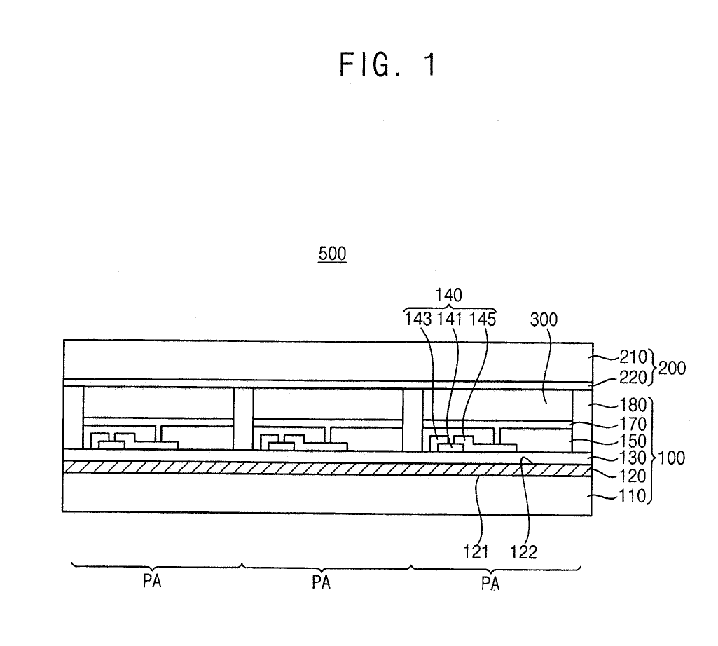

FIG. 1 is a cross-sectional view illustrating a liquid crystal display (LCD) panel, in accordance with an example embodiment of the present invention. Referring to FIG. 1, an LCD panel 500 in accordance with an example embodiment of the present invention includes a first substrate 100, a second substrate 200 facing the first substrate 100, and a liquid crystal layer 300 interposed between the first substrate 100 and the second substrate 200.

In one example embodiment, the first substrate 100 may comprise a lower substrate having a switching element 140 and a pixel electrode 170. The second substrate 200 may comprise an upper substrate having a common electrode 220.

The first substrate 100 defines a plurality of unit pixel areas PA. The first substrate 100 includes a plurality of gate lines (not illustrated) formed on a first base substrate 110 and a plurality of data lines (not illustrated). The first substrate 100 may include a storage line (not illustrated) formed on the first base substrate 110.

The first substrate 100 includes a switching element 140. In one example, the switching element 140 may be a thin-film transistor (TFT) that comprises a gate electrode 141, a source electrode 143, and a drain electrode 145. Though not illustrated in FIG. 1, a gate insulation layer (not illustrated) insulating the source/drain electrodes 143 and 145 from the gate electrode 141 may be formed between the gate electrode 141 and the source/drain electrodes 143 and 145. The switching element 140 includes an active pattern formed on the gate insulation layer. The active pattern may include a semiconductor layer (not illustrated) and an ohmic contact layer (not illustrated) formed on the semiconductor layer. For example, the semiconductor layer may comprise amorphous silicon, and the ohmic contact layer may comprise n+amorphous silicon doped with n-type impurities.

In the embodiment illustrated in FIG. 1, a single TFT is disposed in each unit pixel area PA, but at least two switching elements may be disposed in each unit pixel area PA.

The first substrate 100 may include an insulation interlayer 150 formed on the switching element 140. The insulation interlayer 150 may be an inorganic insulation layer comprising silicon oxide (SiOx) or silicon nitride (SiNx) or may be an organic insulation layer comprising an organic material.

A pixel electrode 170 is disposed on the insulation interlayer 150 in each of the pixel area PA. The pixel electrode 170 is a transparent electrode comprising a transparent conductive material. Examples of the transparent conductive material include indium tin oxide (ITO), indium zinc oxide (IZO), aluminum-doped zinc oxide (AZO), etc.

The pixel electrode 170 is electrically connected to the switching element 140 through a contact hole formed in the insulation interlayer 150. The pixel electrode 170 receives a pixel voltage applied through a drain electrode 145 of the switching element 140 when the switching element 140 is turned on.

According to and embodiment of the present invention, a light-absorption layer 120 is disposed on the first base substrate 110. The light-absorption layer 120 may be disposed between the switching element 140 and the first base substrate 110. The light-absorption layer 120 may comprise a material absorbing all of visible rays. In one example embodiment, the light-absorption layer 120 may comprise an organic material called “black matrix” that is used as a light-blocking layer in a transmissive-type LCD device. The organic material used in the light-absorption layer 120 may include an additive that is well mixed with the organic material and capable of absorbing the visible rays. For example, the light-absorption layer 120 may comprise an organic material including a carbon black.

In one example embodiment, a light-absorbent organic layer 120 is formed on the first base substrate 110 and is treated with heat to form the light-absorption layer 120.

The contrast ratio of a display device refers to the ratio of the luminance of the brightest color to that of the darkest color. For example, the contrast ratio may be calculated from a ratio of luminance while the display device displays a white image to luminance while the display device displays a black image. To increase the contrast ratio, the luminance of the white image should be increased as much as possible, or the luminance of the black image should be decreased as much as possible. Since the reflective LCD device does not use light generated in the reflective LCD device but uses natural light or externally provided artificial light, there are limits to increasing the luminance of the white image in the reflective LCD device. Therefore, the luminance of the black image is required to be decreased as much as possible in the reflective LCD device.

The light-absorption layer 120 absorbs externally provided light when the reflective LCD device displays a dark image, such as a black image. As mentioned above, the light-absorption layer 120 should absorb the externally provided light as much as possible to increase the contrast ratio, and a reduced rate of reflecting the externally provided light is better. That is, a lower reflectivity of the light-absorption layer 120 is better.

In one example embodiment of the present invention, to reduce the reflectivity of the light-absorption layer 120, a surface of the light-absorption layer 120 is treated to increase the roughness of the light-absorption layer 120. For example, when the light-absorption layer 120 includes a first surface 121 facing the first base substrate 110 and a second surface 122 opposite to the first surface 121, the light-absorption layer 120 may be treated by atmospheric plasma to increase the roughness of the second surface 122 of the light-absorption layer 120. Alternatively, in one aspect, an ion beam may be irradiated to the second surface 122 of the light-absorption layer 120 to increase the roughness of the second surface 122.

When the second surface 122 is treated by the atmospheric plasma or the ion beam is irradiated to the second surface 122, though not illustrated in FIG. 1, a plurality of recesses or a plurality of protrusions having random shapes may be formed on the second surface 122, and thus, the second surface 122 may become uneven. When the recesses or protrusions having random shapes is formed on the second surface 122, the reflectivity of the light-absorption layer 120 may be lower than that when the second surface 122 is smooth. In one example embodiment, the recesses or protrusions may be formed on a whole of the second surface 122. Alternatively, the recesses or protrusions may be formed on a portion of the second surface 122. Instead of the protrusions having random shapes, a plurality of protrusions having a uniform shape may be formed on the second surface 122 according to characteristics of the atmospheric plasma.

A protective layer 130 may be disposed on the light-absorption layer 120. The protective layer 130 may cover the light-absorption layer 120. The protective layer 130 may physically or chemically protect the light-absorption layer 120. The protective layer 130 may prevent diffusion of materials included in the light-absorption layer 120 and may prevent the switching element 140 or liquid crystal molecules of the liquid crystal layer 300 from being contaminated by the materials included in the light-absorption layer 120.

The protective layer 130 may comprise an inorganic material, such as silicon oxide (SiOx), silicon nitride (SiNx), etc. For example, the protective layer 130 comprising the silicon oxide may be formed at about 100° C., and the protective layer 130 comprising the silicon nitride may be formed at about 200° C. To apply the protective layer 130 to a flexible substrate (for example, electronic paper), the silicon oxide is preferable because the silicon oxide is formed at relatively lower temperature. However, the material of the protective layer 130 is not limited to the silicon oxide. As needed, the protective layer 130 used in the flexible substrate may comprise the silicon nitride. Further, the protective layer 130 may comprise a mixture of silicon oxide and indium tin oxide.

The second substrate 200 includes a common electrode 220 disposed on the second base substrate 210. The common electrode 220 is a transparent electrode comprising a transparent conductive material. Examples of the transparent conductive material include indium tin oxide (ITO), indium zinc oxide (IZO), aluminum-doped zinc oxide (AZO), etc. The common electrode 220 receives a common voltage. The pixel electrode 170 and the common electrode receive the pixel voltage and the common voltage, respectively, and generate an electric field that is to be applied to the liquid crystal layer 300.

The liquid crystal layer 300 is interposed between the first substrate 100 and the second substrate 200. The liquid crystal layer 300 includes a plurality of liquid crystal molecules. The reflective-type LCD device according to an embodiment of the present invention may include a cholesteric liquid crystal (CLC).

The CLC may reflect a predetermined polarizing light (for example, a circular polarized light) that is a portion of light incident through the second substrate 200. The cholesteric liquid crystal may have texture twisted in a spiral shape. A cholesteric phase may be induced by adding a chiral dopant to a host having a nematic phase.

The CLC does not reflect all of the incident light. The CLC reflects light having a predetermined wavelength that is determined according to a helical pitch of the spiral CLC. That is, the wavelength of light that is to be reflected is determined by the helical pitch of the liquid crystal, and thus, a displayed color may be controlled by adjusting the helical pitch of the liquid crystal. The helical pitch of the liquid crystal may be controlled by a concentration of the chiral dopant. For example, the concentration of the chiral dopant in the CLC may be appropriately adjusted to obtain cholesteric liquid crystals having characteristics of reflecting red light, green light, and blue light, respectively. Accordingly, a predetermined color may be displayed without additional color filters when the CLC is used in the LCD device.

The CLC may be divided into a levorotatory-twisted CLC and a dextrorotatory-twisted CLC according to a twisted direction of the CLC. The levorotatory-twisted CLC has a spiral structure that rotates counterclockwise with respect to a rotational axis of the spiral structure, and the dextrorotatory-twisted CLC has a spiral structure that rotates clockwise with respect to the rotational axis of the spiral structure. The levorotatory-twisted CLC or the dextrorotatory-twisted CLC may reflect a circular polarized light having a predetermined circular direction. For example, the levorotatory-twisted CLC transmits a left-hand circular polarized light, and reflects a right-hand circular polarized light in a predetermined waveband. On the contrary, the dextrorotatory-twisted CLC transmits a right-hand circular polarized light and reflects a left-hand circular polarized light in a predetermined waveband.

A texture state of the CLC may be divided into a planar state, a focal conic state, and a homeotropic state. The planar state means a state when a helical axis of the CLC is substantially perpendicular to a substrate (for example, the first substrate 100). The focal conic state means a state when the helical axis of the CLC is substantially parallel with the first substrate 100.

For example, when a voltage is applied to the CLC in the planar state, the helical axis that was substantially perpendicular to the first substrate 100 is changed to be substantially parallel with the first substrate 100, and then the texture of the CLC transforms to the focal conic state. When a high voltage is applied to the CLC in the focal conic state, the spiral structure is untwisted, and then the texture of the CLC transforms to the homeotropic state. The homeotropic state refers to a state when the liquid crystal molecules of the CLC are arranged in a direction of the electric field applied to the CLC. When the electric field is slowly removed, the texture state may return to the focal conic state. Alternatively, when the electric field is quickly removed, the texture state may return to the planar state.

A relationship between the reflectivity and the texture state of the CLC was experimentally measured. The reflectivity of the CLC in the planar state was about 30%, and the reflectivity of the CLC in the focal conic state was in a range of about 3% to about 4%. The reflectivity of the CLC in the homeotropic state was in a range of about 0.5% to about 0.75%. As mentioned above, the contrast ratio increases as the reflectivity decreases. Therefore, to increase the contrast ratio, the texture state of the CLC during displaying a black image may be the homeotropic state.

In one example embodiment, the liquid crystal layer 300 may be spatially divided by a plurality of walls 180 so that CLC having predetermined characteristics may occupy a predetermined space. For example, the liquid crystal layer 300 may be spatially divided by a plurality of walls 180 so that the levorotatory-twisted CLC and the dextrorotatory-twisted CLC are alternately disposed. However, it should be appreciated that the present invention is not limited to the above-mentioned structure, and the LCD panel 500 according to one or more embodiments of the present invention may not include the walls 180.

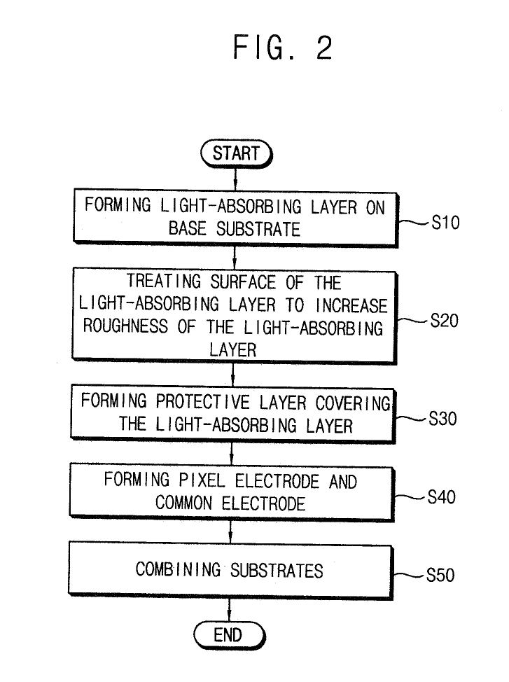

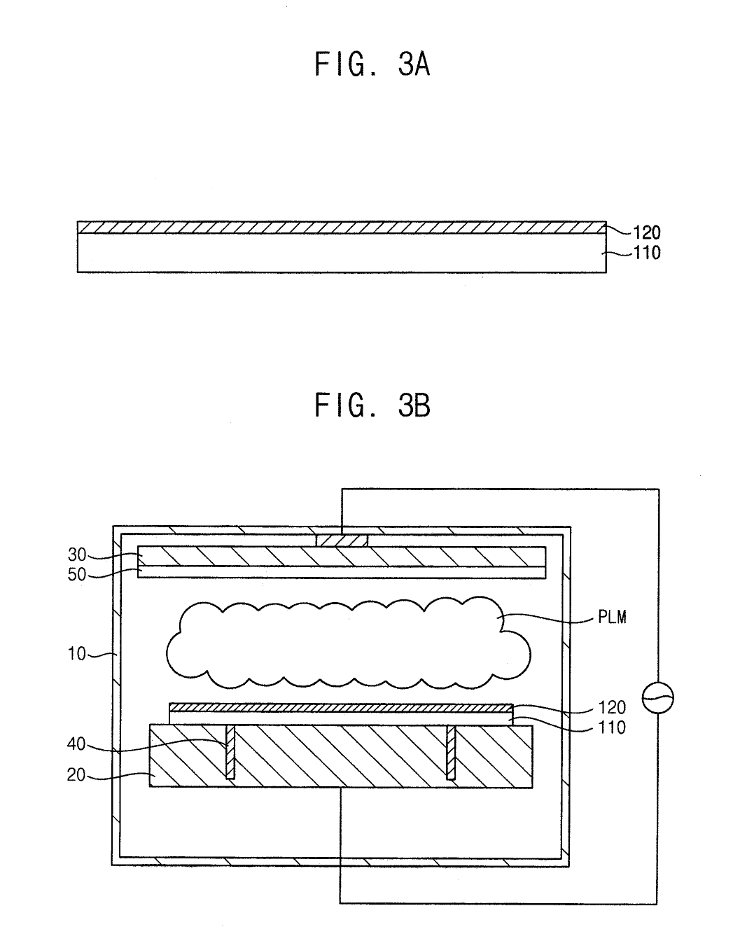

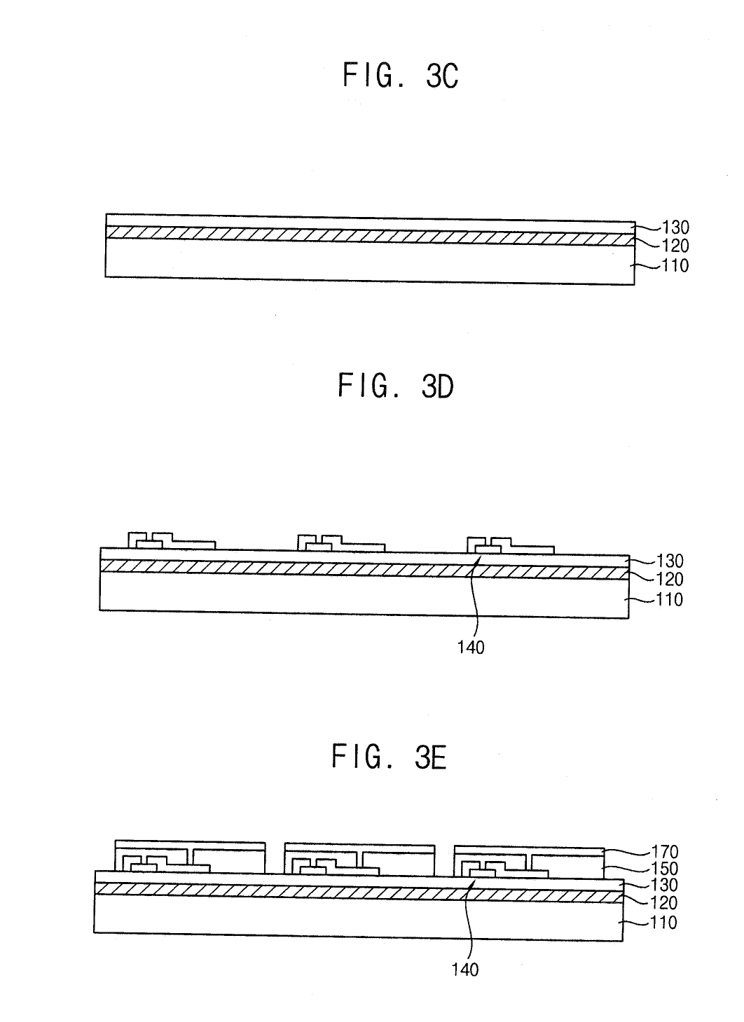

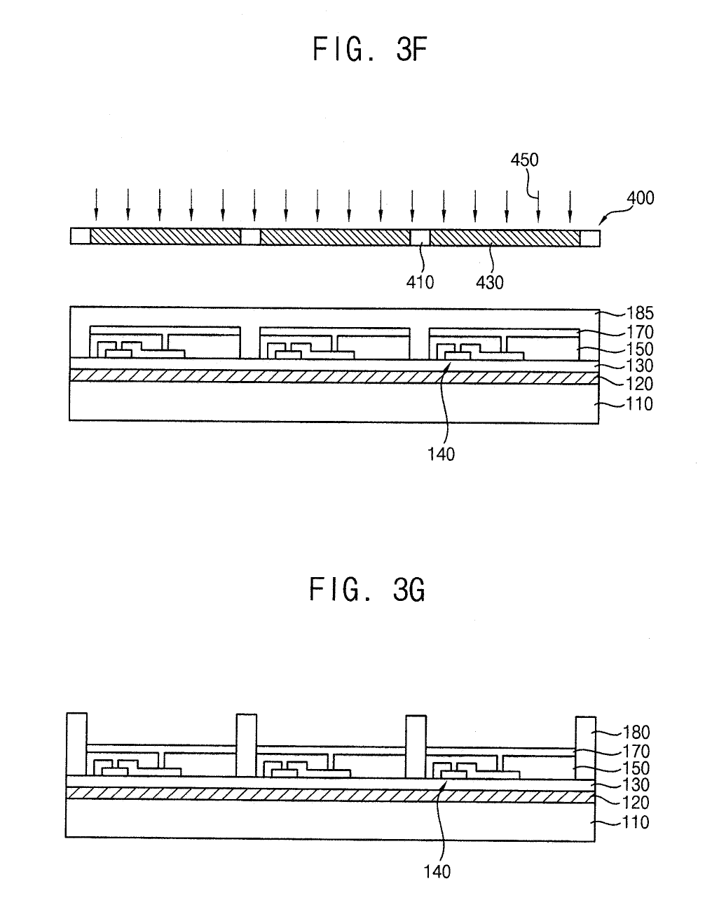

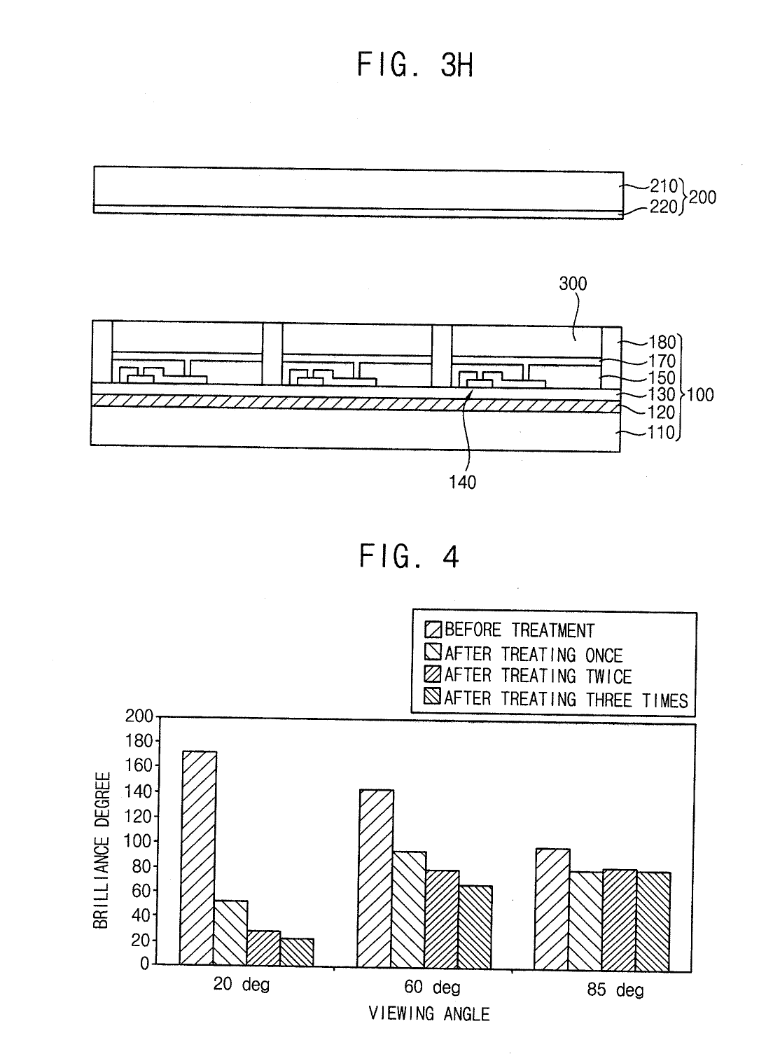

FIG. 2 is a flowchart describing a method of manufacturing the LCD panel illustrated in FIG. 1, in accordance with an embodiment of the present invention. FIGS. 3A to 3H are cross-sectional views for describing processes of the method of manufacturing the LCD panel illustrated in FIG. 1, in accordance with one or more embodiments of the present invention.

Referring to FIG. 2 and FIG. 3A, to manufacture the first substrate 100 of the LCD panel 500, a light-absorption layer 120 is formed on a first base substrate 110 (STEP S10). The light-absorption layer 120 may comprise a material absorbing all of visible rays. In one example embodiment, the light-absorption layer 120 may comprise an organic material called “black matrix” that is used as a light-blocking layer in a transmissive-type LCD device. For example, a light-absorbent organic layer is formed on the first base substrate 110 at a thickness of about 1 μm to about 10 μm, and the light-absorbent organic layer is treated by heat at a temperature of about 220° C. for about one hour to form the light-absorption layer 120. However, the present invention is not limited to the thickness of the light-absorption layer 120 or to the temperature and/or the time of the heat treatment.

The organic material used in the light-absorption layer 120 may include an additive that is well mixed with the organic material and capable of absorbing the visible rays. For example, the light-absorption layer 120 may comprise an organic material including a carbon black.

Referring to FIG. 2 and FIG. 3B, to increase the roughness of the light-absorption layer 120, a surface of the light-absorption layer 120 is treated to increase the roughness of the light-absorption layer 120 (STEP S20). In one example embodiment of the present invention, atmospheric plasma is used to increase the roughness of the light-absorption layer 120. The plasma refers to a state in which electrons are separated from atoms or molecules, and thus, positive ions, electrons, and natural gas are mixed. For example, when an energy larger than an ionization energy of a gas atom is applied to the gas atom, the gas atom is ionized and the plasma is generated. When the reaction that the ions and the electrons are combined to become the natural gas and the ionization reaction are in equilibrium, the generated plasma becomes stable.

The atmospheric plasma has an advantage of reducing costs because the atmospheric plasma may be generated at atmospheric pressure without expensive vacuum equipment. Further, a process using the atmospheric plasma may be achieved in an open space, and thus, a spatial restriction may be relatively less. Examples of a method for generating the atmospheric plasma include a corona discharge method, a dielectric barrier discharge method, a capacitively coupled RF discharge method, etc.

FIG. 3B illustrates one example embodiment of a process for treating the surface of the light-absorption layer 120. The first base substrate 110 including the light-absorption layer 120 is disposed in a chamber 10 in which atmospheric plasma PLM is generated, and an alternating-current voltage is applied to two discharge electrodes 20 and 30. For example, the alternating-current voltage may have a form of a pulse. An interval between the two discharge electrodes 20 and 30 may be controlled by a lift 40.

The atmospheric plasma PLM may be generated, for example, by a dielectric barrier discharge method. In the electric barrier discharge method, a dielectric layer 50 may be disposed at one of the two discharge electrodes 20 and 30 or at both of the discharge electrodes 20 and 30. When a pulse voltage having frequency of several tens kilo-hertz (Hz) is applied to the discharge electrodes 20 and 30, ionization occurs around the discharge electrodes 20 and 30. The dielectric layer 50 stores electrical charges generated by the ionization and disperses the electrical charges throughout the discharge electrodes 20 and 30.

The ions generated by the ionization repeatedly strike the surface of the light-absorption layer 120. Accordingly, a plurality of recesses or a plurality of protrusions having random shapes may be formed on the surface of the light-absorption layer 120, and thus, the surface of the light-absorption layer 120 may become uneven. When the recesses or protrusions having random shapes is formed on the surface of the light-absorption layer 120, and thus, the roughness of the light-absorption layer 120 is increased, the reflectivity of the light-absorption layer 120 may be lower than that when the light-absorption layer 120 is smooth. The protrusions may not have random shapes but have a uniform shape according to characteristics of the atmospheric plasma.

Since a voltage of several kilo-volts (kV) is used in the dielectric barrier discharge method, the plasma may be easily generated by using an ordinary gas, such as oxygen, nitrogen, air, etc., as well as an inert gas such as argon, helium, etc. Intensity of the voltage applied to the plasma or a condition of the gas may be adjusted to control the roughness of the light-absorption layer 120. Although the dielectric barrier discharge method is described in FIG. 3B as a method for generating the atmospheric plasma, the present invention is not limited to the dielectric barrier discharge method, and another method may be used to generate the atmospheric plasma.

When the protrusions or patterns of the light-absorption layer 120 are formed by a lithographic process to increase the roughness of the light-absorption layer 120, the number of steps of the lithographic process is increased, and costs may be increased. Compared to the lithographic process, the surface treatment using the atmospheric plasma has advantages of a low cost and a simple process.

In another example embodiment of the present invention, an ion beam instead of the atmospheric plasma may be irradiated to the light-absorption layer 120 to increase the roughness of the second surface 122. When the ion beam is used to form the plurality of protrusions on the light-absorption layer 120, the shape of the protrusions may be relatively uniform.

Referring to FIG. 2 and FIG. 3C, a protective layer 130 covering the light-absorption layer 120 may be formed on the light-absorption layer 120 (STEP S30). For example, an inorganic material, such as silicon oxide (SiOx), silicon nitride (SiNx), etc., is deposited on the light-absorption layer 120 to form the light-absorption layer 120 having a thickness of about 0.02 μm to about 0.3 μm on the light-absorption layer 120.

The protective layer 130 may comprise an inorganic material, such as silicon oxide (SiOx), silicon nitride (SiNx), etc. The silicon oxide may be formed at about 100° C., and the silicon nitride may be formed at or higher than about 200° C. To apply the protective layer 130 to a flexible substrate (for example, electronic paper), the silicon oxide is preferably applied to the protective layer 130 because the silicon oxide is formed at relatively lower temperature (for example, at a temperature lower than about 150° C.). However, the material of the protective layer 130 is not limited to the silicon oxide.

Referring to FIG. 2 and FIG. 3D, a switching device 140 is formed on the protective layer 130. The switching device 140 may control a pixel in an LCD device operating in an active matrix method. Since a process for manufacturing the switching device 140 is obvious to the ordinary skill in the art, further detailed description will be omitted.

Alternatively, an LCD panel according to embodiments of the present invention may be manufactured in a passive type.

Referring to FIG. 2 and FIG. 3E, an insulation interlayer 150 is formed on the protective layer 130 and the switching element 140. The insulation interlayer 150 may be an inorganic insulation layer comprising silicon oxide (SiOx) or silicon nitride (SiNx), or the insulation layer 150 may be an organic insulation layer comprising an organic material. The insulation interlayer 150 may include a contact hole exposing a portion of electrode of the switching element 140.

A pixel electrode 170 is formed on the insulation interlayer 150 (STEP S40). The pixel electrode 170 is a transparent electrode comprising a transparent conductive material. Examples of the transparent conductive material include indium tin oxide (ITO), indium zinc oxide (IZO), aluminum-doped zinc oxide (AZO), etc. For example, the transparent conductive material is deposited at a thickness of about 0.02 μm to about 0.5 μm on the insulation interlayer 150, and the deposited transparent conductive material is patterned by a lithographic process to form the pixel electrode 170. The thickness of pixel electrode 170 is not limited to the above-mentioned numerical value.

The pixel electrode 170 is electrically connected to the switching element 140 through the contact hole formed in the insulation interlayer 150. For example, the pixel electrode 170 receives a pixel voltage applied through a drain electrode 145 of the switching element 140 when the switching element 140 is turned on.

Though not illustrated in FIG. 3E, in the method of manufacturing the LCD panel according to the present invention, an alignment layer is formed on the pixel electrode 170. The alignment layer may pre-tilt the molecules of the liquid crystal layer. However, the alignment layer is not an essential element, and thus, the process for forming the alignment layer may be omitted.

Referring to FIG. 3F and FIG. 3G, a plurality of walls 180 may be formed between the pixel electrodes 170. The walls 180 may spatially separate the pixels from each other, so that a CLC having predetermined characteristics may occupy a predetermined space. For example, the levorotatory-twisted CLC and the dextrorotatory-twisted CLC may be spatially separated by the walls 180 from each other and alternately disposed. The walls 180 may separately dispose a CLC reflecting light in a range of a predetermined wave band in a predetermined pixel.

In one example embodiment, to form the walls 180, a photoresist layer 185 is deposited at a thickness of about 3 μm to about 10 μm on the first base substrate 110 to cover the pixel electrode 170, as shown in FIG. 3F. A mask 400 is disposed over the photoresist layer 185, and a lithography process is performed. For example, the mask 400 may include a transparent portion 410 transmitting light 450 and a blocking portion 430 blocking the light 450. When the photoresist layer 185 is a negative type, a portion of the photoresist layer 185 where the light 450 is blocked is removed, and a portion of the photoresist layer 185 exposed through the transparent portion 410 remains to become the walls 180. The process for forming the walls 180 is not limited to the above-mentioned embodiment. For example, the order of the process for forming the pixel electrode 170 on the light-absorption layer 120 and the process for forming the walls 180 between the pixel electrodes 170 may be reversed. That is, the walls 180 may be formed on the protective layer 130, and then the pixel electrode 170 may be formed to cover the walls 180 and the protective layer 130.

In the example embodiment illustrated in FIG. 3G, the walls 180 are formed on the first substrate 100, but the walls 180 may be formed on the second substrate 200.

Referring to FIG. 2 and FIG. 3H, a common electrode 220 is formed on a second base substrate 210 to form a second substrate 200.

The common electrode 220 is a transparent electrode comprising a transparent conductive material. Examples of the transparent conductive material include indium tin oxide (ITO), indium zinc oxide (IZO), aluminum-doped zinc oxide (AZO), etc. The common electrode 220 receives a common voltage.

A liquid crystal layer 300 is interposed between the first substrate 100 having the pixel electrode 170 and the second substrate 200 having the common electrode 220. The liquid crystal layer 300 may be deposited on the first substrate 100 having the pixel electrode 170 by an inkjet method. Alternatively, the liquid crystal layer 300 may be deposited by an injection method using a capillary phenomenon.

The liquid crystal layer 300 includes a plurality of liquid crystal molecules. The reflective-type LCD device according to an embodiment of the present invention may include a cholesteric liquid crystal (CLC). The CLC may reflect a predetermined polarizing light (for example, a circular polarized light) that is a portion of light incident through the second substrate 200. The CLC reflects light having a predetermined wavelength that is determined according to a helical pitch of the spiral CLC. Thus, a displayed color may be controlled by adjusting the helical pitch of the CLC. The helical pitch of the CLC may be controlled by a concentration of the chiral dopant. Accordingly, a predetermined color may be displayed without additional color filters when the CLC is used in the LCD device.

A texture state of the CLC may be divided into a planar state, a focal conic state, and a homeotropic state. As described above, according to the experimentally measured relationship between the reflectivity and the texture state of the CLC, the reflectivity of the CLC in the homeotropic state was the lowest. Since the contrast ratio increases as the reflectivity decreases, the texture state of the CLC during displaying a black image may be the homeotropic state to increase the contrast ratio.

The first substrate 100 and the second substrate 200 are combined with the liquid crystal layer 300 interposed between the two substrates 100 and 200 (STEP S50). Alternatively, the first substrate 100 and the second substrate 200 are combined, and then the liquid crystal layer 300 may be injected between the combined substrates 100 and 200.

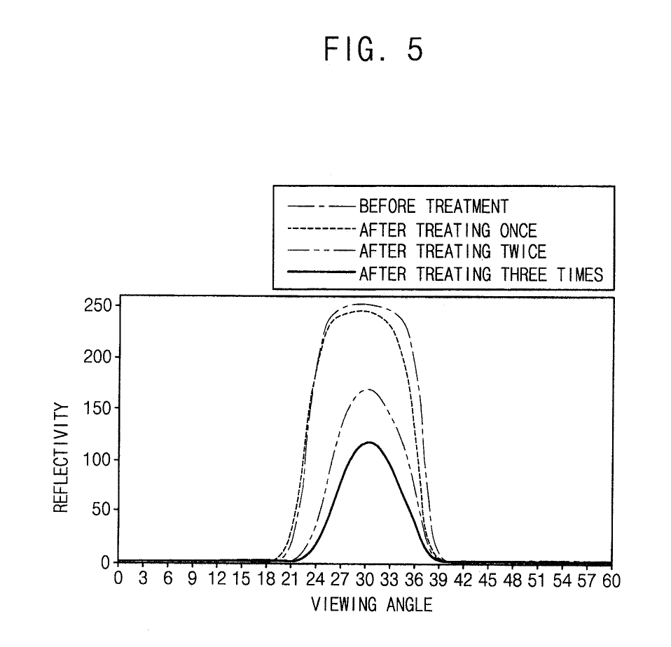

FIG. 4 is a graph showing the brilliance degree of the light-absorption layer after the surface of the light-absorption layer is treated by the atmospheric plasma according to an embodiment of the present invention. FIG. 5 is a graph showing reflectivity of the light-absorption layer before and after the surface of the light-absorption layer is treated by the atmospheric plasma according an embodiment of to the present invention.

As mentioned above, the contrast ratio means the ratio of the luminance of the brightest color to that of the darkest color. To increase the contrast ratio, the luminance of the white image should be increased as much as possible, or the luminance of the black image should be decreased as much as possible. Since the reflective LCD device does not use light generated in the reflective LCD device but uses natural light or externally provided artificial light, there are limits to increasing the luminance of the white image in the reflective LCD device. Therefore, the luminance of the black image is required to be decreased as much as possible in the reflective LCD device. That is, the lower the reflectivity of the light-absorption layer 120 the better.

The horizontal axis of the graph in FIG. 4 represents an observing angle at which an observer looks or a viewing angle. The vertical axis of the graph in FIG. 4 represents the brilliance degree of sample substrates. For example, the sample substrates may include a first sample substrate before the surface of the light-absorption layer 120 is treated, a second sample substrate after the surface of the light-absorption layer 120 is treated once, a third sample substrate after the surface of the light-absorption layer 120 is treated twice, and a fourth ample substrate after the surface of the light-absorption layer 120 is treated three times.

As shown in the graph in FIG. 4, the brilliance degree was considerably reduced by the surface treatment, for example, using the atmospheric plasma. Particularly, the brilliance degree is considerably reduced at a viewing angle of about 60 degrees that is an international standard for measuring the brilliance degree, and thus, an LCD panel having high contrast ratio at a side view may be manufactured.

The horizontal axis of the graph in FIG. 5 represents an observing angle at which an observer looks or a viewing angle. The vertical axis of the graph in FIG. 5 represents reflectivity of the sample substrates. The reflectivity shown in the graph in FIG. 5 is a direct illumination reflectivity (DI) reflectivity that was measured when light directly illuminates the reflective-type LCD panel at a substantially perpendicular angle to the LCD panel. For example, the sample substrates may include a first sample substrate before the surface of the light-absorption layer 120 is treated, a second sample substrate after the surface of the light-absorption layer 120 is treated once, a third sample substrate after the surface of the light-absorption layer 120 is treated twice, and a fourth ample substrate after the surface of the light-absorption layer 120 is treated three times. Each reflectivity of the sample substrates was measured at a viewing angle of about 20 degrees to about 40 degrees under the direct illumination.

As shown in the graph in FIG. 5, when the surface of the light-absorption layer 120 was treated, the maximum reflectivity at a viewing angle of about 30 degrees was less than 150 that is DI reflectivity of a conventional electronic ink used at electronic paper.

As described above, when the surface of the light-absorption layer 120 is treated by the method using the atmospheric plasma according to an embodiment of the present invention, the brilliance degree and the reflectivity of the reflective-type LCD panel may be reduced. Therefore, a reflective-type LCD panel having high contrast ratio may be manufactured.

According to the example embodiments of the present invention, the contrast ratio of a reflective-type LCD panel may be increased. Particularly, when embodiments of the present invention are applied to electronic paper, an electronic book, an electronic newspaper, etc., which do not employ a backlight assembly, the quality of a displayed image may be improved.

The foregoing is illustrative of the present disclosure and is not to be construed as limiting thereof. Although a few example embodiments of the present invention have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific example embodiments disclosed, and that modifications to the disclosed example embodiments, as well as other example embodiments, are intended to be included within the scope of the appended claims. Embodiments of the present invention are defined by the following claims, with equivalents of the claims to be included therein.

What is claimed is:

1. A liquid crystal display (LCD) panel comprising:
a first substrate comprising:
a first base substrate;
a light-absorbing layer comprising a first surface facing the first base substrate and a second surface opposite to the first surface, the second surface comprising greater roughness than that of the first surface; and
a pixel electrode formed on the light-absorbing layer;
a second substrate including a common electrode facing the pixel electrode; and
a liquid crystal layer disposed between the first substrate and the second substrate.

2. The LCD panel of claim 1, wherein the second surface of the light-absorbing layer is treated by using atmospheric plasma or an ion beam.

3. The LCD panel of claim 1, wherein the second surface of the light-absorbing layer includes a plurality of protrusions having random shapes.

4. The LCD panel of claim 3, wherein the protrusions are formed on a whole of the second surface.

5. The LCD panel of claim 1, wherein the light-absorbing layer is an organic layer comprising carbon black.

6. The LCD panel of claim 1, further comprising a protective layer formed on the light-absorbing layer to cover the light-absorbing layer.

7. The LCD panel of claim 6, wherein the protective layer comprises silicon oxide.

8. The LCD panel of claim 1, wherein the liquid crystal layer comprises a cholesteric liquid crystal, and wherein a texture state of the cholesteric liquid crystal is a homeotropic state during display of a black image.

9. The LCD panel of claim 1, further comprising a plurality of walls formed between the pixel electrodes.

10. A method of manufacturing a display substrate of an LCD device, the method comprising:
forming a light-absorbing layer on a base substrate;
treating a surface of the light-absorbing layer to increase a roughness of the surface of the light-absorbing layer;
forming a switching element on the light-absorbing layer; and
forming a transparent electrode electrically connected to the switching element.

11. The method of claim 10, wherein forming the light-absorbing layer includes:
depositing a light-absorbent organic layer on the base substrate; and
treating the light-absorbent organic layer by heat to cure the light-absorbent organic layer.

12. The method of claim 11, wherein the light-absorbent organic layer includes carbon black.

13. The method of claim 10, wherein the treating the surface of the light-absorbing layer includes increasing the roughness of the light-absorbing layer by using atmospheric plasma.

14. The method of claim 10, wherein the treating the surface of the light-absorbing layer includes increasing the roughness of the light-absorbing layer by irradiating an ion beam to the light-absorbing layer.

15. The method of claim 10, further comprising forming a protective layer on the light-absorbing layer after the treating the surface of the light-absorbing layer.

16. The method of claim 15, wherein the protective layer comprises silicon oxide formed at a temperature lower than about 150° C.

17. A method of manufacturing a reflective-type LCD device, the method comprising:
forming a light-absorbing layer on a first substrate;
treating a surface of the light-absorbing layer to increase a roughness of the surface of the light-absorbing layer;
forming a pixel electrode in each pixel area of the first substrate;
forming a second substrate including a common electrode facing the pixel electrode; and
disposing a cholesteric liquid crystal layer between the first substrate and the second substrate.

18. The method of claim 17, wherein the light-absorbing layer is an organic layer including carbon black.

19. The method of claim 17, wherein the treating the surface of the light-absorbing layer includes increasing the roughness of the light-absorbing layer by using atmospheric plasma.

20. The method of claim 17, further comprising forming a protective layer on the light-absorbing layer after the treating the surface of the light-absorbing layer.
